(19) United States
(12) Patent Application Publication
(10) Pub. No.: US 2008/0303286 A1
(43) Pub. Date: Dec. 11, 2008

(54) WIND ELECTRICAL GENERATION SYSTEM

(76) Inventor: Peter D. Vangel, South Hadley, MA (US)

Correspondence Address: O''Shea Getz P.C., 1500 MAIN ST. SUITE 912, SPRINGFIELD, MA, 01115, US

(21) Appl. No.: 11/758,717

(22) Filed: Jun. 6, 2007

(51) Int. Cl. F03D 9/00

(52) U.S. Cl. 290/55

(57) ABSTRACT

A wind electrical generation system includes a relatively large number of small, miniature wind-driven electrical generators or turbines arranged together in various predetermined configurations. Each generator includes a spinning wheel with a plurality of vanes driven by the wind flowing through a plurality of air channels. Each vane may be formed as a scoop to increase the surface area thereby increasing the air capture area of each vane. As each wheel rotates the wheel generates electricity that is captured and utilized for residential and/or commercial use. A control system preferably provides for a constant air velocity and pressure of the air stream in the air channels during operation of the system.

### BACKGROUND OF THE INVENTION

The invention relates in general to a wind electrical generation system and in particular to such a system that utilizes a relatively large number of small, miniature wind-driven generators arranged together to provide a source of electricity.

In the art of wind electrical generation systems, it is known to use wind farms that comprise a plurality of relatively large, propeller-driven generators or turbines. These generators are typically located in geographical areas, both onshore and offshore, with certain wind characteristics, for example, an average wind speed of ten mph or greater and a relatively constant wind speed. For each generator, the force or kinetic energy of the wind impinges on the propeller blades causing them to rotate, which causes each corresponding generator to generate electricity that is combined together with that of the other generators and the total electrical power output is then used for various purposes (e.g., regional electrical grids for residential and commercial use or grid-isolated locations such as rural areas). A typical, modern wind generator can provide up to six megawatts of electrical power. Thus, a wind farm comprising a large number of such generators can provide power for a relatively large number of residences and/or businesses. Generating electricity by using the power of the wind is becoming more popular for a number of reasons, including the fact that wind generators have relatively little operating cost once installed and generate little or no waste products. Even though such generators currently produce less than 1% of the world-wide electricity use, wind power generation has more than quadrupled between the years 2000 and 2006 and is predicted to become more prevalent in the future.

However, despite their increasing popularity, these wind generators have a number of drawbacks. For example, their physical location must be precise with respect to the associated prevailing wind patterns (e.g., micro-siting) so as to capture as much of the available wind at that location as possible. The generators must be pointed into the wind for proper wind capture, which sometimes necessitates the use of computer-controlled motors to adjust the position of the blades. Also, they tend to be very large (for example, a height of 400 feet and a turbine blade length of 180 feet), and they must be spaced apart by a relatively large distance so as to not affect the proper operation of adjacent or neighboring generators, which increases the overall size of the geographical area needed to implement the wind farm. Further, these large propeller-driven wind generators are expensive to build and install (particularly for offshore applications), and are difficult to integrate together into a single overall system. In addition, these generators rotate at relatively low RPMs which necessitates the use of a gearbox to provide for a quicker rotation more suitable for generating electricity, and are aesthetically visually unpleasant to many, relatively noisy, and environmental unfriendly (e.g., harmful to birds). These drawbacks have caused a number of proposed wind farms worldwide to have never been built. Offshore locations tend to be more expensive than onshore locations for various reasons, notably the cost to build. Also, these generators generally cannot be placed in relatively high wind areas, for example, winds greater than fifty mph.

What is needed is a wind electrical generation system that utilizes a relatively large number of small and inexpensive electrical generators that rotate rapidly and are integrated together in an array or network, the network generating a relatively large amount of electrical power.

### SUMMARY OF THE INVENTION

Briefly, according to an aspect of the invention, a wind electrical generation system includes a relatively large number of small, miniature wind-driven electrical generators or turbines which can be arranged together in one of many various configurations, such as a rack-mounted array. Each generator includes a spinning wheel or disk with a plurality of vanes. Each vane may be formed with a scoop-like configuration near the outer periphery thereof to increase the surface area thereby increasing the air capture area of each vane. An air channel in the form of, e.g., a cylindrical opening or through-hole in the body or frame of the generator facilitates the flow of the air stream through the generator and thus through the overall system. A portion of the outer periphery of each radial vane of each generator protrudes into the air channel. The force of the air stream in the air channel striking the vanes rotates the vanes in the natural rotational direction of the wheel. The air channel facilitates constant laminar air flow through the channel, which keeps air turbulence relatively low and provides for relatively high electrical efficiency of each generator. As each wheel rotates the generator produces electricity that is collected and utilized for various purposes (e.g., added to a residential power grid). A control system is provided that works with sensors and active transducers disposed at various locations in the air stream to sense the airflow and provide for constant air velocity and pressure of the air flow during operation of the system through use of feedback air flow introduced into the system air flow.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a perspective view of a miniature electrical generator used in a wind electrical generation system of the present invention;

FIG. 2 is a perspective view of the electrical generator portion of the generator of FIG. 1;

FIG. 3 is an illustration of a wheel portion of the generator of FIG. 1 having a plurality of air scoops formed on the wheel;

FIG. 4 is a perspective view of one of the air scoops of FIG. 3;

FIG. 5 is an illustration of the wheel portion of the generator of FIG. 1 with respect to a tubular air channel;

FIG. 6 is an illustration of a plurality of wheels of a corresponding plurality of generators of FIG. 1 with respect to the tubular air channel of FIG. 5;

FIG. 7 is an illustration of a plurality of wheels of a corresponding plurality of generators of FIG. 1 with respect to a wrap-around tubular air channel and two straight tubular air channels;

FIG. 8 is an illustration of the wheels and air channels of FIG. 7 together with a plurality of air sensors and transducers and feedback air;

FIG. 9 is a diagram of a preferred embodiment of a wind electrical generation system of the present invention;

FIG. 10 is a perspective view of a flared input inlet that captures the input air stream; and

FIG. 11 is a block diagram of a control system used with the wind electrical generation system of FIG. 9.

### DETAILED DESCRIPTION OF THE INVENTION

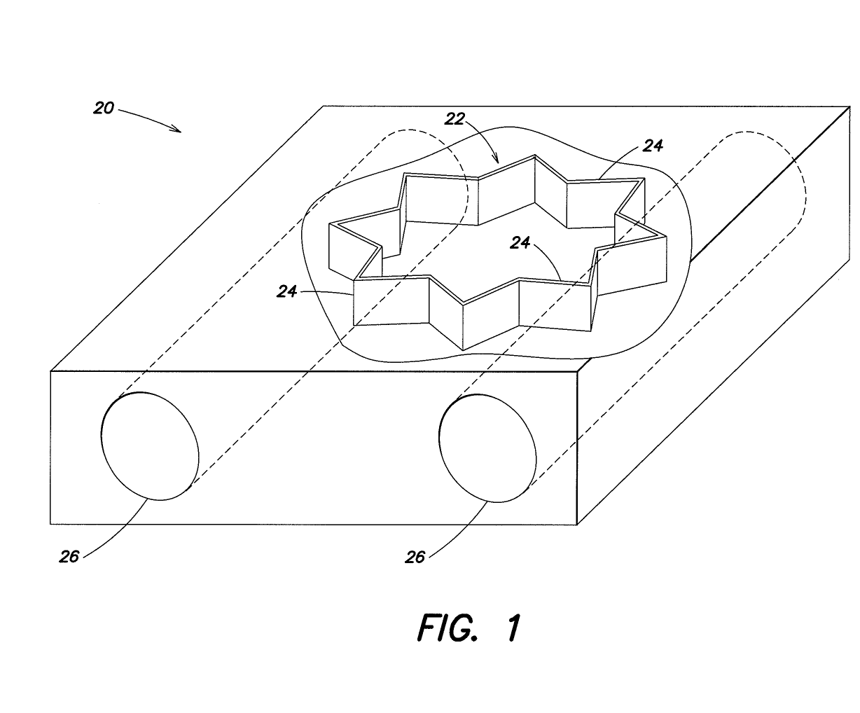

Referring to FIG. 1, there illustrated is a preferred embodiment of a single, relatively small, miniature electrical generator 20 (“MEG”), a plurality of which are arranged together in a wind electrical generation system of the present invention, described and illustrated in detail hereinafter. Preferably, each MEG 20 may be similar in physical size and structure to the cooling motor or fan (“muffin” fan) used in many types of electronic devices (e.g., personal computers) for cooling of the electronic components of such a device. Thus, the approximate size of the MEG 20 may be three inches wide by three inches high by one inch deep. The muffin fan is typically a low-cost device ($0.50-$2.00 each), is readily available in bulk quantities, operates with little or no noise, and is rugged having a relatively long operational lifetime. The MEG 20 used in the system of the present invention has many of these qualities.

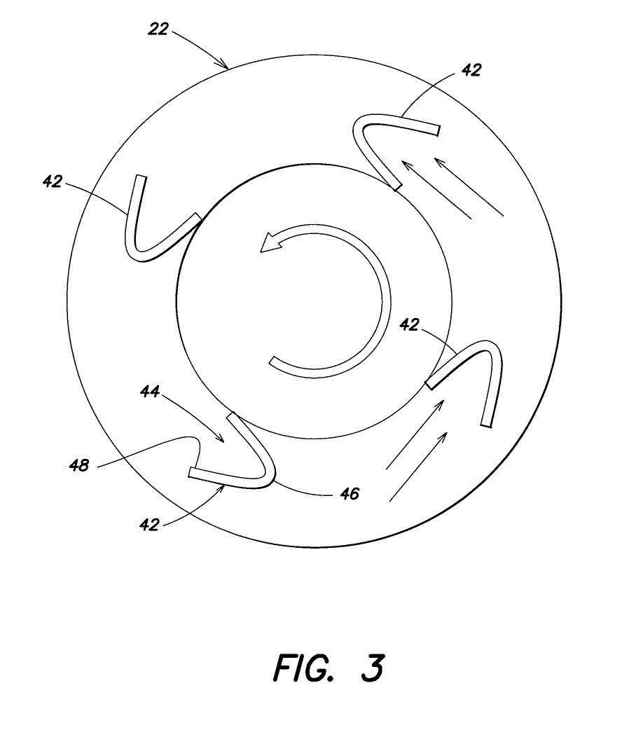

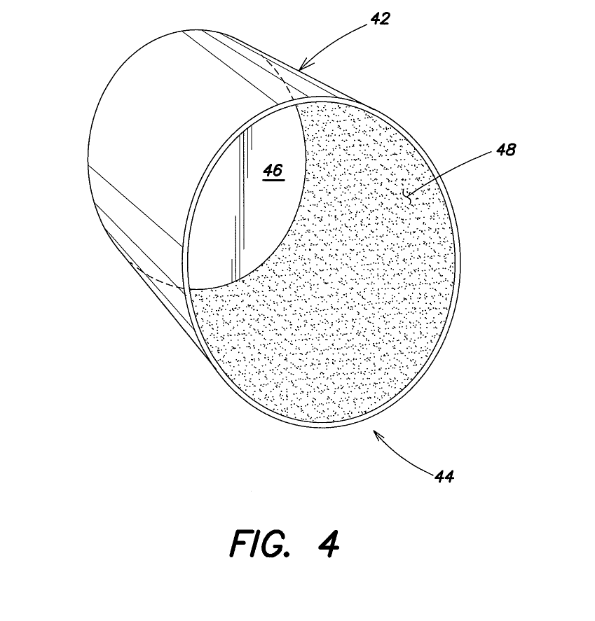

In the system of the present invention, to operate the MEG 20 as a generator instead of a motor, the fan is replaced by a spinning propeller disk or wheel 22 with a plurality of radial vanes 24. Each vane 24 may have an air catcher or scoop (FIGS. 3-4) formed on an outer periphery or on some other location of the vane 24. Also, the muffin fan winding coils and magnets are configured electrically as a generator instead of as a motor, as described and illustrated hereinafter. The diameter of the wheel 22 may be two and one half inches. The spinning wheel 22 is of relatively light weight, which results in little moving mass and, thus, a high rate of rotation of the wheel 22 when driven by the wind. Generally, as the RPM of the wheel 22 increase so does the electrical power output of the MEG 20. Since relatively little mass of the MEG 20 is being moved by the wind, the mass load is actually the electrical generator itself. Thus, the wind is pushing against the back electro-motive force (EMF) of the generator, which in actuality is the resulting electrical power generated by the system of the present invention.

The body of the MEG 20 along with the wheel 22 may be formed of plastic or other suitable material by a known injection molding process or some other manufacturing process. The body of the MEG 20 may have a pair of straight or curved cylindrical holes or air channels 26, one on each side of the wheel 22, formed therein throughout the body of the MEG 20. The air channels 26, which are illustrated in FIG. 1 as being straight, are preferably smooth-walled cavities that facilitate the flow of a laminar air stream therethrough. A laminar air flow or air stream is desirable since turbulent air streams tend to provide unwanted mechanical stresses. As described in detail hereinafter, in the system of the present invention the air channels 26 of each MEG 20 are connected together in an array so as to be in fluid communication with each other, thereby providing an air flow through some portion or all of the wind electrical generation system. A portion of the outer periphery of each vane 24 protrudes into the air stream. The force of the wind in the air stream in the air channels 26 rotates the vanes 24 in the natural rotational direction of the wheel 22. The air channels 26 of each MEG 20 facilitate constant laminar air flow therethrough, which keeps air turbulence relatively low and provides for relatively high electrical efficiency of each MEG 20. Each air channel 26 therefore is designed to have adequate energy capacity for the number of MEGs 20 within the channel 26. Each air channel 26 can be viewed as a conveyor belt of air which has miniature flywheels “hooked” into the air stream. The faster the air flows in the channels 26, the faster the wheels 22 turn. As each wheel 22 rotates, the generator portion of each MEG 20 produces electricity that is collected and utilized for various purposes (e.g., added to a residential power grid).

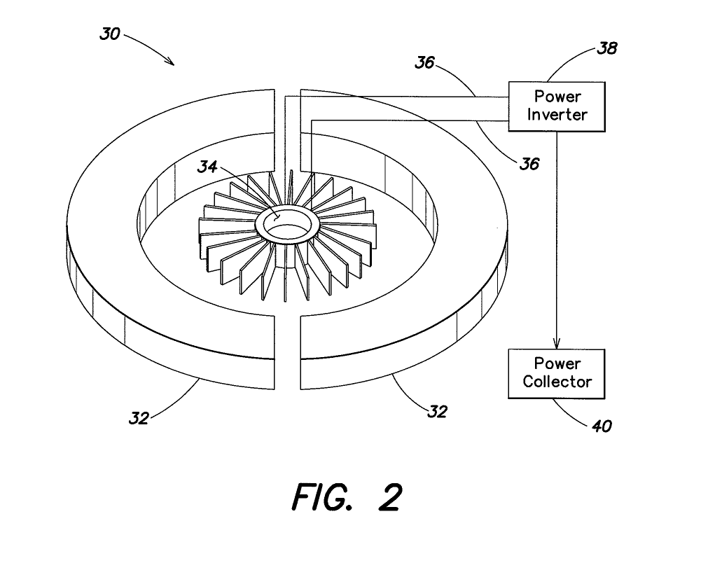

Referring to FIG. 2, there illustrated is the generator portion 30 of each MEG 20. The generator portion 30 includes a pair of permanent magnets 32 in the shape of half circles disposed in a surrounding relationship to a coil 34 of wire. Essentially, for each MEG 20 the motor coil arrangement of a typical muffin fan is replaced by a generator coil and magnet arrangement, as should be readily apparent to one of ordinary skill in the art. As the corresponding wheel 22 of the MEG 20 rotates, electricity is generated in the generator wire coil 34 which is connected by wires 36 to a power inverter 38. In this exemplary embodiment, the magnets 32 rotate with the wheel 22 while the wire coil 34 does not rotate. However, as is known in the art of generators, the magnets 32 may be stationary while the wire coil 34 rotates. The power inverter 38 is utilized if the generator portion 30 of each MEG 20 produces a direct current (“DC”) voltage (e.g., 12 VDC). The power inverter 38 converts the DC voltage to an alternating current (“AC”) voltage and provides the resulting AC voltage to a power collector 40. If instead the generator portion 30 of each MEG 20 provides an AC voltage, then the power inverter 38 may not be needed. Further, it may be possible that if each MEG 20 produces a DC voltage, the power collector 40 collects this DC power from each MEG 20 and converts it to an AC voltage. As such, the power inverter 38 may be part of the power collector 40. The power collector 40 may be connected to all of the MEGs 20 in the system of the present invention to collect and store and/or provide the generated AC power from each MEG 20 or from selected ones of the MEGs 20 for various residential and/or commercial uses. For example, the electricity stored by the power collector 40 may be provided to a local or regional power grid from where it is distributed to each home and business.

Referring to FIG. 3, there illustrated is a wheel 22 of a typical MEG 20. A total of fifteen scoops 42 (although only four scoops 42 are illustrated in FIG. 3 for clarity) may be provided in a preferred embodiment of the wheel 22. The scoops 42 may be spaced evenly around the outer periphery or circumference of each wheel 22, although the scoops 42 may be positioned on each vane 24 inward from the outer periphery. Referring also to FIG. 4, each scoop 42 may be cup-shaped and have a frontal opening 44 and a closed back 46 that together better holds the captured portion of the air stream flowing through the air channels 26 into which the scoops are “embedded” by the position of the rotating wheel 22 with respect to the laminar air stream. Further, each scoop 42 may be preferably aerodynamically shaped to reduce wind or air drag. Thus, each scoop 42 acts similarly to a spinnaker in sailing with respect to its ability to capture more of the kinetic energy of the wind for propulsion purposes, to thereby rotate the wheel 22 at a faster speed, which allows for a greater amount of electricity to be generated by the MEG 20. Also, each scoop 42 may have its inner surface 48 exposed to the air laminar stream roughened to an extent (for example, in the form of embossed cones) to thereby increase the amount of the surface area of the scoop 42 that captures the wind.

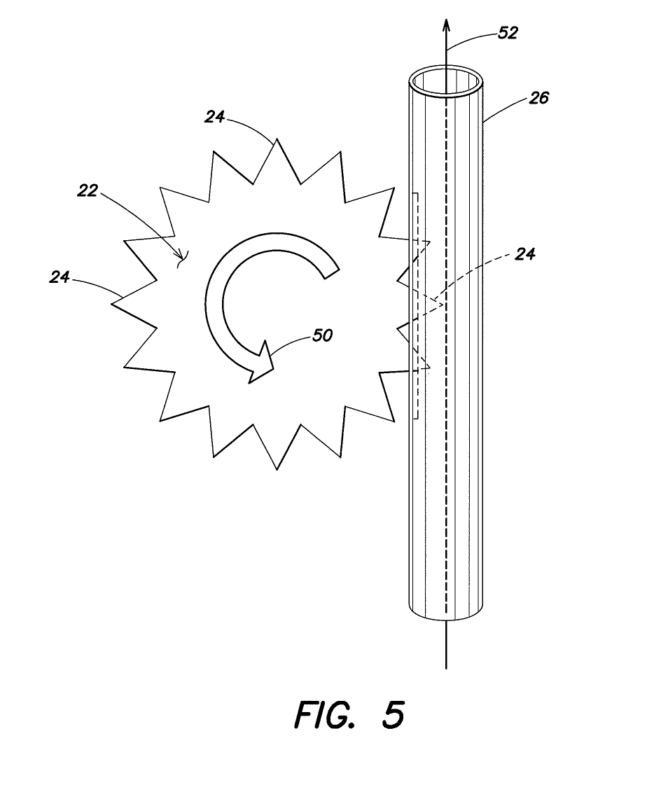

Referring to FIG. 5, there illustrated is a single wheel 22 of a typical MEG 20 having the outer peripheral portions of the vanes 24 with the scoops 42 located within an opening (e.g., a slotted opening) of the associated air channel 26 of the MEG 20 as the wheel 22 rotates, for example, in a counter-clockwise direction as illustrated by the arrow 50 in FIG. 5. The air channel 26 of FIG. 5 is illustrated as being straight. The air channel 26 may be integrated into the MEG 20 itself, as illustrated in FIG. 1. In the alternative, the air channel 26 may not be integrated as a part of the MEG 20 but instead may comprise a separate tube (e.g., a cylindrical tube made from plastic or other suitable material) having an opening (e.g., slotted) into which the outer periphery of the rotating vanes 24 may be located during operation of the MEG 20. If the air channel 26 comprises a tube, the preferred diameter of that tube may be one inch. The direction of the laminar air flow through the air channel 26 is indicated by the arrow 52 in FIG. 5. In operation, the input air comprises the captured air stream from the wind and is introduced into one end of the air channel 26. In FIG. 5 the input air is introduced in the bottom of the air channel 26 as illustrated. The input air then travels upwards through the air channel 26 as indicated by the arrow 52 in FIG. 5 where it strikes the air scoops 42 of the radial vanes 24 that protrude into the air channel 26, thereby rotating the wheel 22 of the MEG 20 and generating electricity.

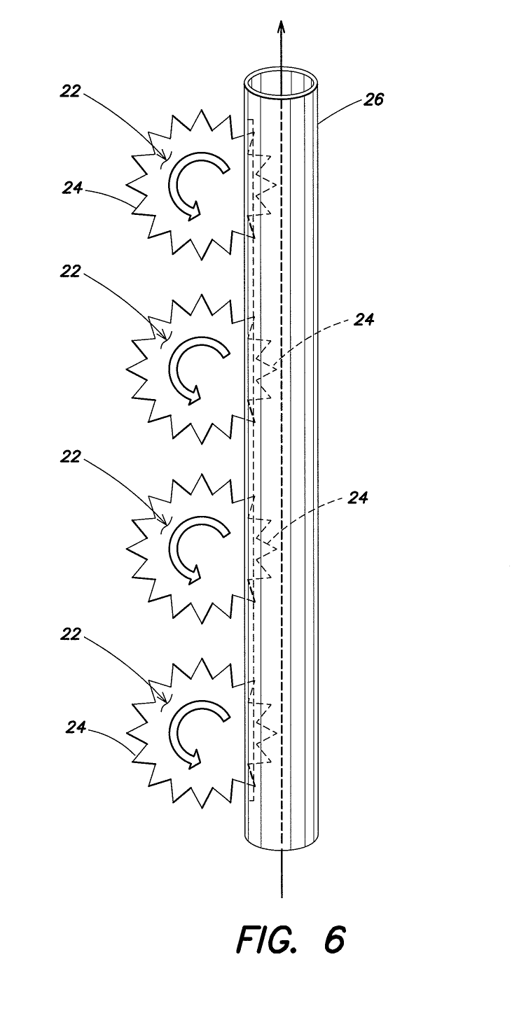

Referring to FIG. 6, there illustrated are four wheels 22 of four corresponding MEGs 20 aligned in a straight line. As illustrated, the wheels 22 are disposed next to and to the left of a straight air channel 26, which may comprise a plastic tube separate from the MEGs 20 or the air channel 26 may be those channels 26 formed in the corresponding bodies of the MEGS 20 as illustrated in FIG. 1. In the latter case, the MEGs 20 of FIG. 1 may be disposed in an adjacent abutting relationship to each other so as to maintain a continuous air channel 26. Alternatively, some or all of the MEGs 20 in the system of the present invention may be disposed adjacent or near one another but need not abut one another such that there is some amount of spacing therebetween. As such, a conduit such as a cylindrical tube may be used between the MEGs 20 to connect the air channels 26 together thereby keeping air stream contiguous. Still further, whether or not the MEGs 20 are abutting one another, there may be an opening provided for a portion or all of the air stream flowing in the air channels 26 to be diverted away from the air stream flowing to the MEGs 20 disposed “downstream” from this opening. This way, the air stream in the air channels 26 may be selectively “tapped” at certain locations within the system of the present invention.

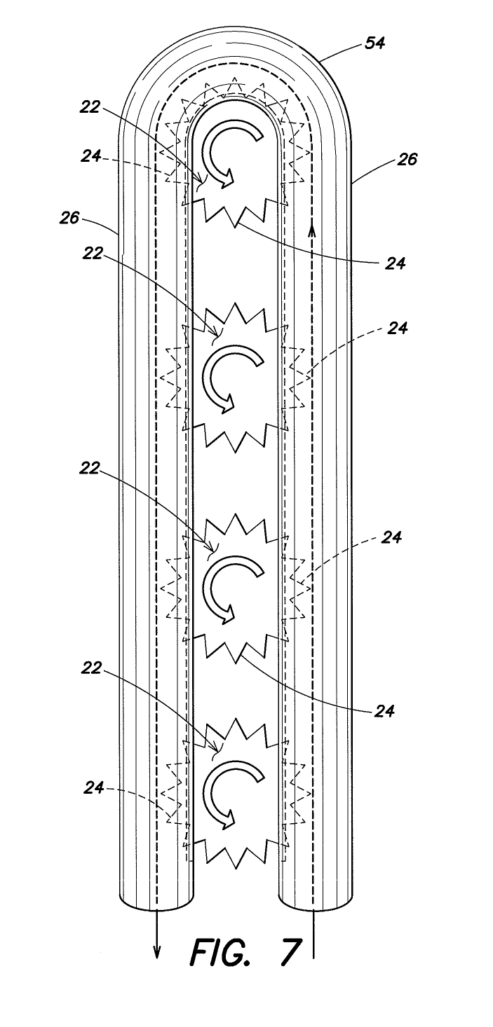

Referring to FIG. 7, there illustrated is another configuration where the four wheels 22 of the four corresponding MEGs 20 are again aligned in a straight line, as in FIG. 6. However, in FIG. 7 a second straight air channel 26 is disposed next to and to the left of the wheels 22. The dual air channels 26 may be similar to those illustrated in FIG. 1 and being formed integrally with the body of each MEG 20. In the alternative, the dual air channels 26 may comprise separate plastic cylindrical tubes disposed apart from each MEG 20. The use of dual air channels 26 with the MEGs 20 instead of a single air channel 26 provides for a greater amount of the laminar air stream to be captured by each MEG 20, resulting in faster spinning of each wheel 22, which results in a larger electrical power output produced by each MEG 20. The configuration of FIG. 7 also includes a third air channel 54 which is illustrated as being an arc or semicircular in shape. The third air channel 54 is a “wrap-around” air channel and is disposed such that each end of the channel 54 interfaces with a corresponding one of the straight air channels 26 in FIG. 7. That way, when viewing FIG. 7 the laminar air flow is contiguous up through the right air channel 26, through the curved wrap-around air channel 54, and then down through the left air channel 26. The wrap-around air channel 54 may be formed internally as part of a MEG 20, or it may be easier and less costly to manufacture and utilize a cylindrical arc-shaped tube made from plastic or other material to form the wrap-around air channel 54. Also, as seen in FIG. 7, a larger number of the vanes 24 of the uppermost wheel 22 are disposed in the left, right and wrap-around air channels 26, 54. This provides for a greater amount of propulsion generated by the associated MEGs 20. Essentially, the use of the wrap-around air channel 54 and also of the air channels 26 on both sides of the wheels 22 allows for more of the vanes 24 of each wheel 22 to be driven by the wind, resulting in a faster rotation of the wheels 22, thereby resulting in a greater amount of electricity provided for by each MEG 20.

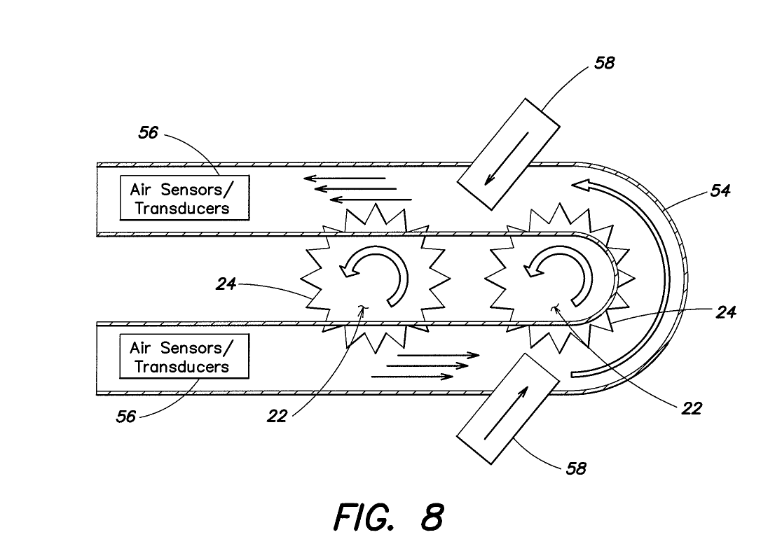

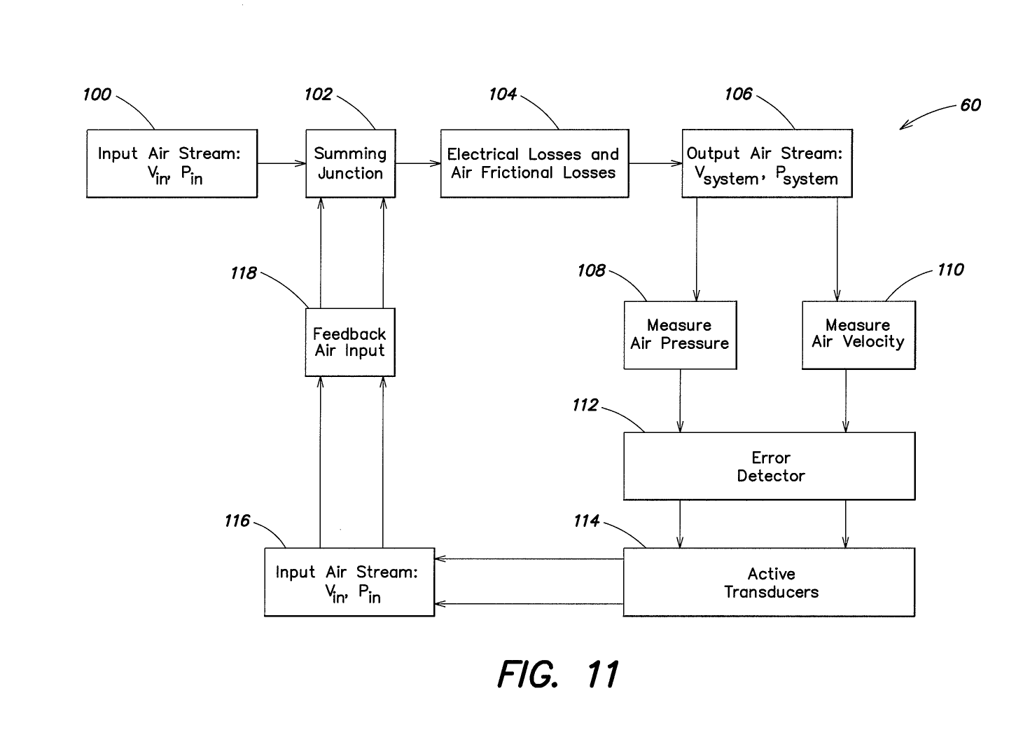

Referring to FIG. 8, there illustrated is a portion of the configuration of the MEGs 20 of FIG. 7, with the addition of air sensors and transducers 56, together with feedback air 58, disposed or introduced at appropriate locations into the laminar air stream flowing through the air channels 26. The air sensors 56 may comprise an air velocity sensor that senses the speed of the laminar air flow through the corresponding air channels 26. The air sensors 56 may also include an air pressure sensor that senses the pressure of the laminar air flow through the corresponding air channels 26. A plurality of velocity and/or pressure sensors 56 may be provided at certain locations within the various air channels 26, 54, including at some or all of the various inputs and outputs of the air channels 26 within the various configurations of the system of the present invention. The outputs of the sensors 56 may be provided to a control system 60, which is described and illustrated in more detail hereinafter with respect to FIG. 11. The control system 60 operates preferably to maintain an air stream through the air channels 26, 54 with constant velocity and pressure so as to better provide a stable source of electricity.

The transducers 56 may comprise any type of transducer that may be utilized to maintain the velocity and/or pressure of the air stream through the air channels 26, 54 at predetermined values; for example, in a preferred embodiment, at a constant velocity and pressure. For example, the transducer 56 may comprise an active transducer such as a moving diaphragm similar to the well-known loudspeaker. The diaphragm may be controlled by the control system 60 of FIG. 11 depending on the sensed value of the velocity and pressure of the air stream in the air channels 26, 54. Another example of an active transducer is a sliding wing that adjusts the amount of an opening in the air channels 26, 54 at appropriate locations in the air channels. The sliding wing may be a moving device controlled by a motor commanded by the control system 60. Alternatively, a passive transducer such as a baffle without any control by the control system 60 may be used to shape the air stream in the air channels 26, 54, thereby controlling the velocity and pressure of the air flow.

The feedback air 58 may be introduced into a selected one or more, or all, of the air channels 26, 54, depending on the required amount of feedback air needed to achieve the desired goal, for example, of constant air flow in the air channels 26, 54. The feedback air may be obtained from various sources, such as being tapped off from one or more of the air channels 26, 54 themselves, from the wind itself without undergoing any “shaping” by the system of the present invention, or from a source of air external to the wind generation system of the present invention.

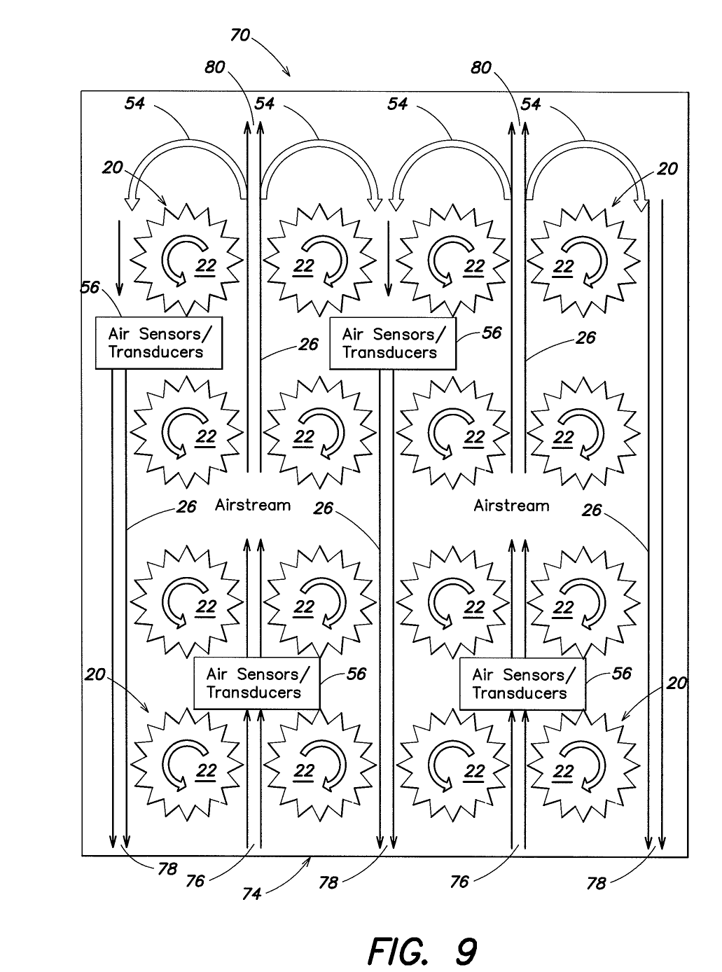

Referring to FIG. 9, there illustrated is a preferred embodiment of a wind electrical generation system 70 of the present invention that incorporates the teachings of the configurations illustrated in the previous figures. In this exemplary embodiment, the system 70 comprises a plurality (e.g., sixteen) of MEGs 20 arranged in a grid or array of four MEGs 20 per column and four MEGs 20 per row. This square shaped arrangement of MEGs 20 is purely exemplary—any number of MEGs 20 may be arranged in various different configurations (square, rectangular, or otherwise), in light of the teachings herein. Due to the relatively small size of each MEG 20, it is not inconceivable that many thousands of MEGs 20 may be integrated together into a configuration that provides a relatively large amount of electricity.

As illustrated in FIG. 9, an air channel 26 is provided between each abutting two columns of MEGs 20. An air channel 26 is also provided on the outer boundary of each of the leftmost and rightmost column of MEGs 20 in FIG. 9. Wrap-around air channels 54 are provided to connect together in fluid communication certain pairs of the columnar air channels 26. If the MEG 20 of FIG. 1 is utilized in the system 70, then the air channels 26 are those formed integrally within the body of each MEG 20. As such, the MEGs 20 in the array of FIG. 9 may be in an adjacent abutting relationship. Each air channel 26, 54 in the array of FIG. 9 essentially “shapes” the wind and locates it where it can be utilized by the MEGs 20 efficiently for electrical power generation. This physical array of MEGs 20 and air channels 26, 54 may be achieved through use of a rack 74 that holds the MEGs, air channels and any additional components utilized in the system 70 of the present invention. For example, the plurality of MEGs 20 and the additional components of the system 70 (e.g., the air sensors/transducers 56, feedback air 58, and the control system 60) may be assembled within a plastic or metal rack 74, which can then be further assembled as part of a building or some other type of housing or structure. In a particular example, a number of arrays such as that of FIG. 7, each comprising a plurality of MEGs 20, can be disposed back to back and have the input air from the wind provided to the corresponding air channels 26 accordingly. This way, a relatively large amount of electricity can be generated in a relatively small physical space.

Also illustrated in FIG. 9 are the various air sensors and transducers 56 disposed at certain locations within the various air streams flowing through the air channels 26, 54. In FIG. 9, the input air stream is introduced at various one or more locations 76 into the air channels 26 where it interacts with the MEGs 20. Also, the output air is output from the air channels 26 at various one or more locations 78. If desired, the output air may also be taken at locations 80 where the straight air channels 26 meet the wrap around air channels 54, or can be taken from locations within the straight air channels 26 themselves. Air output from the system 70 from any one or more of these locations 78, 80 may be used as the feedback air 58 (FIG. 8) in modified or unmodified form (e.g., pressure and/or velocity). In operation, as the wind is input into the air channels 26 at the input locations 76 it flows through the air channels 26, 54, where it forces the wheels 22 with the scoops 42 of the corresponding MEGs 20 to rotate and thus generates electricity which is collected by the power collector 40 (FIG. 2).

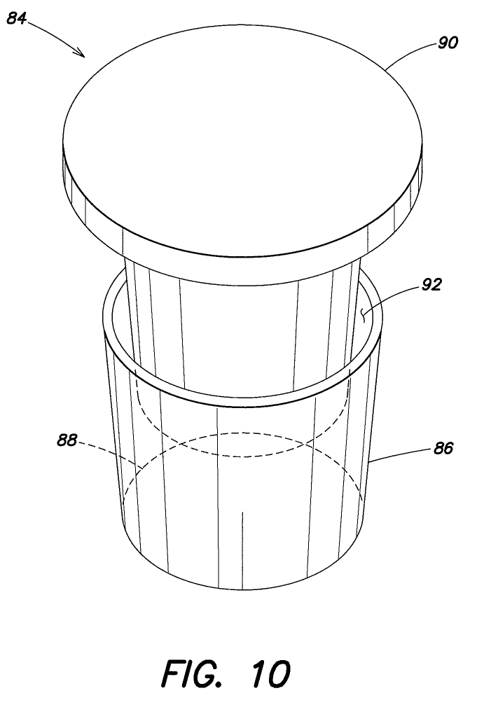

Referring to FIG. 10, a flared horn 84 is illustrated that may be used to assist in the capture of the wind and provide the captured wind energy to the wind electrical generation system 70 of FIG. 9 at the input air locations 76. The flared horn 84 provides for a greater amount of wind to be captured than a simple cylindrical opening in an air channel 26. The flared horn 84 is an example of an omnidirectional primary wind input to the system 70. The flared horn 84 allows wind from any direction to be “grabbed” and input into the system 70 for conversion to electrical energy. A plurality of flared horns 84 may be utilized by the system 70 of the present invention—one or more for each air input location 76. As illustrated in FIG. 10, the flared horn comprises a lower or “basket” portion 86 with an open bottom 88 together with a “top” portion 90. The open bottom 88 may be connected directly to an air channel 26 at a system input location 76. The top portion 90 is movable in and out of the basket portion 86 by, e.g., a motor or other actuator device and controlled by the control system 60 of FIG. 11 to control the amount of an opening 92 for the wind to enter the flared horn 84. Thus, the top portion 90 of the flared horn 84 may be such that it moves up or down depending upon wind speed.

Referring to FIG. 11, there illustrated is a block diagram of the control system 60 which preferably comprises an electronic control that utilizes feedback in the form of sensing and adjustment of the actual pressure and velocity of the air stream in the air channels 26, 54 to desired values. This way the air pressure and velocity of that air stream is controlled in a manner that keeps the pressure and velocity, for example, constant in a preferred embodiment. Alternatively, the air pressure and/or velocity may be controlled to have different characteristics, such as varying in a certain manner. The velocity and pressure of the air stream within the system 70 at one or more of the input air locations 76 are sensed by sensors 56 similar to those illustrated, e.g., in FIG. 9 and the sensed velocity and pressure values are provided to the system 60 in a block 100. The input velocity and pressure values are mixed or summed with corresponding adjusted values of air velocity and pressure in a summing junction 102. The summed values for air velocity and pressure are then provided to a block 104 that accounts for any electrical losses and air frictional losses in the system 70. The output air velocity and pressure of the air stream at the various output air stream locations 78 are sensed in a block 106. The actual values for air velocity and pressure within the air channels 26, 54 are sensed by the sensors 56 in the blocks 108, 110, and the sensed values are provided to an error detector 112. The error detector 112 compares the sensed values of air pressure and velocity with desired values and provides the results to the transducers 56 in a block 114. The transducers adjust the air velocity and pressure at the input air stream at the locations 76 in a block 116. The adjusted values for air pressure and velocity are then provided a feedback block 118 which then provides them to the summing junction 102. The action of the control system 60 results in a “shaped wind” flowing through the system 70 of the present invention.

The control system 60 utilizes basic closed loop feedback control in conjunction with the sensors and transducers 56 to control the velocity and pressure of the air stream in the air channels 26, 54 to desired values. This helps to implement the overall operation of the system of a plurality of miniature electrical wind-driven generators under controlled pressure and velocity laminar flow air stream conditions. In a preferred embodiment, the velocity and pressure are controlled to within +/−5% to achieve the desired amount of control over the electricity generated by the system of the present invention.

In an example of the power generating capacity of a MEG 20 utilized as part of the wind electrical generation system 70 of the present invention, an input air flow source of a wind that is steady at thirty miles per hour translates to an air flow of:

30 mph=0.5 mile/minute=2640 feet/minute.

If a MEG 20 having a wheel 22 with a 1.91 inch diameter is utilized, then the wheel circumference is:

(π)(1.91 inch)=6 inches=0.5 feet

With an air flow of 2640 ft/min and a revolution length of 0.5 ft, an RPM is given by:

RPM=Air Flow/Rev. Length=2640 ft/min/0.5 ft/rev=5280 RPM

Thus, for a wind speed of 30 mph, 5280 RPM are obtained for the wheel 22. From a system perspective, it is preferable to keep the MEGs 20 operating at a constant RPM; this helps to insure relatively long operational lifetimes.

As another example, a ten foot cubic space (similar to a small tool shed) is filled with as many MEGs 20 as possible. Each MEG is 3 inch square by 1.0 inch thick. The volume of each MEG is thus:

(3 in)(3 in)(1.0 in)=9 in³

The volume of the ten foot cube is likewise;

[(10 ft)(12 in/ft)]³=1,728,000 in³

Therefore, the number of MEGs 20 that can fit in the tool shed is given by:

1,728,000 in³/9 in³=192,000 MEGs

Now, assume a desired wind speed of 30 mph and an output power per MEG of 10 watts, then the total system power is:

(192,000 MEGs)(10 W/MEG)=1.92 MW

Thus, nearly 2 megawatts can be obtained from a 10 foot wind cube.

In another example, a system air speed of 40 mph is desired. If the same wheel 22 is utilized as in the previous example, the RPM can be calculated from:

40 miles/hour=0.67 miles/min=3538 feet/min and disk revolution (circumference)=(π)(1.91 inch)=6 inches=0.5 feet.

Thus, RPM=3538 ft/min/0.5 ft/rev=7075 RPM.

As mentioned above, and depending on the number of MEGs 20 utilized, the wind electrical generation system 70 of the present invention may be physically embodied in a rack 74. The rack 74 may have slots or openings where “plug in” card containing a plurality of MEGs 20 can be inserted. The rack 74 may also facilitate the holding of the plastic tubular air channels 26, 54, if utilized, along with the electronics embodying the control system 60, and the sensors and transducers 56. Appropriate connections for the input wind air and the feedback air are also provided in the rack.

All of the components of the wind electrical generation system of the present invention are mass produced and thus inexpensive and readily available. Advantageously, the wind electrical generation system of the present invention is capable of being integrated on a mass scale, which means the use of thousands, millions or even billions of the miniature electrical generators integrated together such that their electrical outputs are combined.

The system 70 utilizes wind power from any wind source, natural or created, and is insensitive to wind direction since the system can have air inputs from any direction. Also, the system can be located in geographical regions that are not amenable to traditional propeller driven generators. For example, the system can be located near an exposed outcropping of rock or other such obstacles that restrict air flow. As such, with relatively high average speeds often there exists a venturi effect which naturally leads to increases in air pressure. Also, the system 70 of the present invention can be place in relatively high wind areas, for example winds greater than fifty mph. In such areas, the system of the present invention may include features such as particularly shaped obstacles that deliberately restrict the wind flow, thereby increasing the pressure and velocity of the air stream that is then fed to the MEGs. These features may also be used in lower wind areas to increase the pressure and velocity of the usable air stream.

The system 70 of the present invention has the additional benefits of having little environmental impact, has low noise, is much less expensive than traditional large scale propeller generators, and can be aesthetically pleasing.

Although the present invention has been illustrated and described with respect to several preferred embodiments thereof, various changes, omissions and additions to the form and detail thereof, may be made therein, without departing from the spirit and scope of the invention.

What is claimed is:

1. A wind electrical generation system, comprising:
a plurality of electrical generators, each generator having a wheel that rotates when moving air contacts at least a portion of the wheel, each wheel having a plurality of vanes, where each generator generates electricity when the wheel rotates;
a first air channel into which wind enters to form an air stream comprised of moving air, the first air channel being at least partially enclosed, where a portion of at least one of the wheels of the corresponding one of the plurality of generators is disposed in the first air channel, where the first air channel directs the air stream therethrough in a predetermined direction, where at least two of the electrical generators are connected in fluid communication by the first air channel;
at least one sensor that senses at least one parameter of the air stream and provides an indication of the sensed at least one parameter; and
a control system that is responsive to the indication of the sensed at least one parameter of the air stream to control the air stream to a predetermined condition.

2. The wind electrical generation system of claim 1, further comprising a power collector that collects the electricity generated by each of the plurality of generators.

3. The wind electrical generation system of claim 1, where the at least one sensor comprises an air velocity sensor that senses the velocity of the air stream at a predetermined location with respect to the first air channel.

4. The wind electrical generation system of claim 3, where the control system controls the velocity of the air stream within the first air channel to a constant value.

5. The wind electrical generation system of claim 4, where the control system controls the velocity of the air stream within the first air channel to a constant value by providing a feedback air stream having an adjusted velocity value into the air stream in at least one position within the first air channel.

6. The wind electrical generation system of claim 1, where the at least one sensor comprises an air pressure sensor that senses the pressure of the air stream at a predetermined location with respect to the first air channel.

7. The wind electrical generation system of claim 6, where the control system controls the pressure of the air stream within the first air channel to a constant value.

8. The wind electrical generation system of claim 7, where the control system controls the pressure of the air stream within the first air channel to a constant value by providing a feedback air stream having an adjusted pressure value into the air stream in at least one position within the first air channel.

9. The wind electrical generation system of claim 1, where the first air channel is formed in a body of at least one of the plurality of electrical generators.

10. The wind electrical generation system of claim 1, where the wheel of at least one of the plurality of electrical generators includes at least one air scoop disposed at a position on one of the vanes on the wheel, where the scoop captures an amount of the air stream.

11. The wind electrical generation system of claim 10, where the position of the air scoop on the one of vanes is at an outer periphery thereof.

12. The wind electrical generation system of claim 10, where the wheel of the at least one of the plurality of electrical generators includes a plurality of the air scoops, where each air scoop is disposed at a position on a corresponding one of the vanes on the wheel.

13. The wind electrical generation system of claim 1, where the air stream comprises a laminar air stream.

14. The wind electrical generation system of claim 1, further comprising a second air channel through which the air stream flows, the second air channel being at least partially enclosed, where a portion of at least one of the wheels of the corresponding one of the plurality of generators is disposed in both the first and second air channels, where the second air channel directs the air stream therethrough in a predetermined direction.

15. The wind electrical generation system of claim 1, further comprising a third air channel that connects the first and second air channels in fluid communication.

16. The wind electrical generation system of claim 1, further comprising a transducer disposed within the first air channel, where the transducer adjusts at least one parameter of the air stream to a predetermined value.

17. The wind electrical generation system of claim 16, where the transducer comprises an active transducer in the form of a moving diaphragm whose movement is controlled by the control system.

18. The wind electrical generation system of claim 16, where the transducer comprises a passive transducer in the form of a baffle.

19. The wind electrical generation system of claim 1, further comprising a flared horn disposed at an inlet of the first air channel, where the flared horn captures the wind and provides the captured wind as the air stream into the first air channel.

20. A wind electrical generation system, comprising:
a plurality of electrical generators arranged in an array, each generator having a wheel that rotates when moving air contacts at least a portion of the wheel, each wheel having a plurality of vanes, where each generator generates electricity that is collected when the wheel rotates;
a plurality of air channels arranged within the array and connected together in fluid communication to form a primary air channel, the primary air channel having at least one input to allow wind to enter to form an air stream comprised of moving air flowing through the primary air channel, where a portion of the wheel of each generator is disposed in the primary air channel;
a plurality of sensors that sense at least one of the pressure and velocity values of the air stream and provide corresponding sensed signals indicative thereof; and
a control system, responsive to the sensed signals, that controls the air stream to a predetermined condition using a feedback air stream having an adjusted value for at least one of the pressure and velocity of the primary air stream, where the feedback air stream is introduced into the primary air stream at one or more predetermined locations.
